(19) United States
(12) Patent Application Publication
(10) Pub. No.: US 2007/0169893 A1
(43) Pub. Date: Jul. 26, 2007

(54) Heat sealing tool

(75) Inventors: Winfried Koenig, Balingen (DE); Claudius Wersching, Balingen (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Bizerba GmbH & Co. KG, Balingen (DE)

(21) Appl. No.: 11/489,209

(22) Filed: Jul. 19, 2006

(30) Foreign Application Priority Data
Jul. 25, 2005 (DE) 10 2005 035 567.6

(51) Int. Cl. B32B 37/00

(52) U.S. Cl. 156/379.8; 156/583.1

(57) ABSTRACT

A heat sealing tool is proposed. The heat sealing tool comprises a heat transfer device made of a metallic material for contacting objects to be sealed, and a support on which the heat transfer device is held. The heat transfer device is fixed by means of bridge elements to the support, and the bridge elements are arranged in one piece on the heat transfer device.

The present disclosure relates to the subject matter disclosed in German application number 10 2005 035 567.6 of Jul. 25, 2005, which is incorporated herein by reference in its entirety and for all purposes.

### BACKGROUND OF THE INVENTION

The invention relates to a heat sealing tool.

Such heat sealing tools are used, for example, in packaging machines to seal sheets of film to one another and thereby provide a sealed space for accommodating packaging material.

A machine is known from DE 34 43 914 for making plastic bags using a heatable sealing bar for forming sealing seams in an at least two-layered thermoplastic film. The sealing bar has a sealing edge and is joined to a support extending over substantially the entire length of the sealing bar and having a plurality of holders arranged at spacings from one another in a row along the sealing bar. The sealing bar is fixed to the holders which are designed as guides for displacement of the sealing bar in a plane of displacement. Owing to forces acting in the plane of displacement, the sealing bar is capable of bending outwards in this plane. A pretensioning device is provided between the support and the sealing bar for counteracting with its pretensioning force displacements of the sealing bar running in the plane of displacement along the guides formed by the holders in the direction towards the support.

An apparatus for thermal sealing or high-frequency sealing and punching sheets in known from DE 43 10 916.

An apparatus for heat sealing thermoplastic material, comprising a sealing jaw with a jaw body and a thermal strip, is known from EP 0 634 328 A1. The jaw body is of one-piece manufacture and has a groove in which the thermal strip is mechanically anchored. An electrically insulating layer is located between the jaw body and the groove.

### SUMMARY OF THE INVENTION

In accordance with the invention, a heat-sealing tool is provided which can be manufactured in a simple way and exhibits good thermal properties.

In accordance with an embodiment of the invention, a heat transfer device is provided for contacting objects to be sealed, the heat transfer device being made of a metallic material, and a support is provided, on which the heat transfer device is held, the heat transfer device being fixed by means of bridge elements to the support, and the bridge elements being arranged in one piece on the heat transfer device.

A heat transfer device made of a metallic material can be manufactured in a simple way in basically any configuration. In particular, bridge elements can be integrally formed thereon.

By means of the bridge elements, the heat transfer device can be held with minimal thermal contact on the support. In particular, the area of heat transmission from a heat body of the heat transfer device to the support can be minimized.

In particular, the heat transfer device can be detachably fixed to the support, so that quick exchangeability is ensured. Quick assembly during the manufacturing process is also enabled.

A heat body of the heat transfer device can be held at a spacing from the support by means of the bridge elements. Cold bridges can thereby be avoided. It is thereby also made possible for the heat body to be of thicker configuration, so that, for example, it has greater mechanical stability.

When the bridge elements are arranged in one piece on the heat transfer device, the heat transfer device can be manufactured in a simple way. Furthermore, owing to the inherent elasticity of the metallic material of the heat transfer device, fixing, and, in particular, clamped fixing, of the heat transfer device on the support can be achieved in a simple way.

In particular, a plurality of bridge elements are provided. A stable fixing of the heat transfer device on the support is thereby achieved over the entire length of the support or the heat transfer device (the lengthwise direction not necessarily being a single linear direction).

It is expedient for the bridge elements to be arranged in spaced relation to one another. The area of heat transmission from a heat body to the support can thereby be minimized, with a secure fixing being achieved.

In this connection, it is particularly expedient for the bridge elements to have a width in a direction in which adjacent bridge elements are spaced from one another, which is smaller than the spacing between adjacent bridge elements.

In particular, the spacing between adjacent bridge elements is at least three times and preferably at least five times greater than the width of a bridge element. The transmission of heat from the heat transfer device to the support (which is made from a material having low thermal conductivity) can thereby be kept low.

It is quite particularly advantageous for the heat transfer device to be clipped by means of the bridge elements onto the support. Owing to the clipping-on, the heat transfer device can be held by spring clamping action on the support. This enables quick assembly of the heat transfer device on the support and, consequently, simple manufacturability and easy exchangeability. The heat transfer device can be detached from the support, so that simple exchange in the event of wear is possible.

It is expedient for bridge elements to be arranged on opposite sides of the heat transfer device. A secure fixing on the support is thereby achieved.

In particular, the bridge elements protrude from a heat body. Arranged on or in the heat body is, in particular, a heating device for supplying heat to the heat transfer device. A spacing of the heat body from the support is achieved by means of the bridge elements, so as to minimize the area of heat transmission over which a flow of heat can flow from the heat body to the support.

In particular, the bridge elements protrude transversely to a contact surface of the heat transfer device. A spacing between a heat body and the support is thereby achieved in a simple way.

It can be provided that the support has one or more recessed areas for bridge elements to bear at least partially thereon. In particular, a clamped connection between the heat transfer device and the support is thereby obtained. Furthermore, assembly of the heat transfer device is simplified, as the spacing between the heat body and the support is predefined by a recessed area.

It is expedient for a bridge element to have a bridge portion by means of which it protrudes from a heat body of the heat transfer device. The bridge portion can be formed with such a small cross section that the flow of heat from the heat body to the support is minimized.

It can be provided that a base portion for fixing the heat transfer device to the support is arranged on the bridge portion. A secure fixing of the heat transfer device to the support can be achieved by means of the base portion.

It is expedient for the base portion to be broadened in relation to the bridge portion so as to provide an enlarged contact surface for the fixing.

It is then expedient for the base portion to be broader than the bridge portion in relation to a direction in which adjacent bridge elements are spaced from one another on the same side of the heat transfer device. A larger contact surface is thereby provided.

It is quite particularly advantageous for the sum of all widths of the bridge portions to be considerably smaller than the length of the periphery of the heat body. The area of heat transmission through which the flows of heat can pass from the heat body to the support is thereby minimized. In particular, the length of the periphery is at least three times or preferably at least five times greater than the sum of all widths of the bridge portions.

Bridge elements are expediently arranged at opposite edges of the heat body. For example, the heat transfer device can thereby be manufactured in a simple way.

It is expedient for the support to be made from a plastic material, which, in particular, is a heat insulator.

It is expedient for the support to have slanted edge areas on a side facing a heat body of the heat transfer device. The width of the heat body away from the contact surface towards the support is thereby increased. After placing bridge elements on the slanted areas and exerting a pressure on the heat transfer device, a transverse force can be exerted on the bridge elements so as to push these into a recessed area on the support. Owing to an elastic design of the bridge elements, the heat body is held clamped on the support. The heat transfer device can thus be clipped in a simple way onto the support.

The support expediently has one or more stepped areas at opposite sides for bridge elements to bear thereon. Such a stepped area defines a recessed area on which a bridge element can bear at least partially on the support so as to fix this bridge element by spring clamping on the support. Furthermore, a blocking face is provided, via which the height of a heat body of the heat transfer device is defined with respect to the support. This, in turn, facilitates the manufacture.

A heating device is preferably associated with the heat transfer device. This is, in particular, a resistance heater. A contact surface can thereby be heated over its entire surface area.

For example, the heat transfer device comprises one or more heat coils. These can be integrated, for example, by vulcanization into a heat body or arranged on a heat body. The thermal resistance between the heating device and the heat body can thereby be kept small.

In order to obtain good sealing results, it is advantageous for the heat transfer device to comprise a substantially flat contact surface.

It is quite particularly advantageous for a contact surface of the heat transfer device to be provided with an anti-stick coating. This is, for example, a PTFE coating. The service life in terms of soiling can thereby be increased.

The heat transfer device is manufactured using, for example, a sheet of metal. For example, a basic shape is punched out of a metal sheet and provided with a heating device. The heat transfer device can thus be manufactured in a simple way.

It is quite particularly advantageous for a heat body of the heat transfer device to be spaced from a support. Cold bridges can thereby be substantially avoided.

It is expedient for an intermediate layer to be provided between a heat body of the heat transfer device and the support. A space between the heat transfer device and the support can be filled out at least partially by the intermediate layer in such a way that the mechanical stability of the heat sealing tool is increased in relation to contact pressures thereon. In particular, a sagging of the heat body can be substantially prevented.

In particular, the intermediate layer is of heat-insulating design. For example, the intermediate layer is formed using a foam material such as porous silicone with corresponding heat-insulating properties.

The following description of preferred embodiments serves in conjunction with the drawings to explain the invention in greater detail.

### BRIEF DESCRIPTION OF THE DRAWINGS

FIG. 1 shows a plan view of an embodiment of a heat sealing tool;

FIG. 2 shows a sectional view taken along line 2-2 according to FIG. 1; and

FIG. 3 shows a partial view of the heat sealing tool according to FIG. 1 from the side in the direction A.

### DETAILED DESCRIPTION OF THE INVENTION

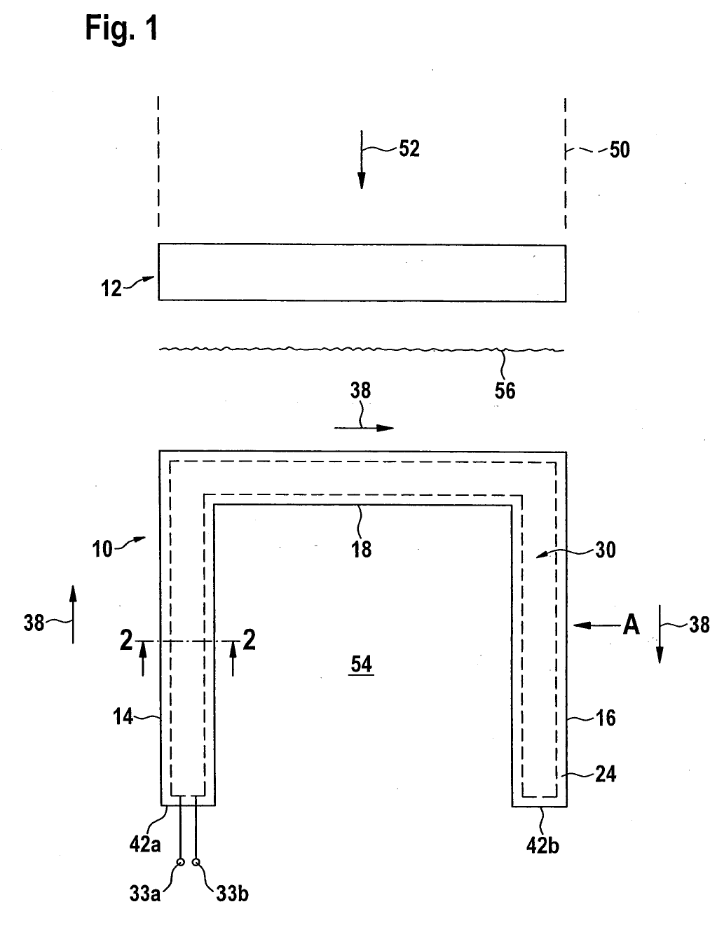

An embodiment of a heat sealing tool according to the invention, shown in FIG. 1 and designated 10 therein, is arranged, for example, in a packaging machine. The packaging machine may, for example, include a further heat sealing tool 12.

In the embodiment shown in FIG. 1, the heat sealing tool 10 is of U-shaped configuration with a first leg 14, a second leg 16 in parallel spaced relation thereto and a crosspiece 18 between the first leg and the second leg. The crosspiece 18 extends substantially perpendicularly to the first leg 14 and the second leg 16.

The heat sealing tool 12 is, for example, I-shaped.

A heat sealing tool according to the invention may be manufactured in optional shapes.

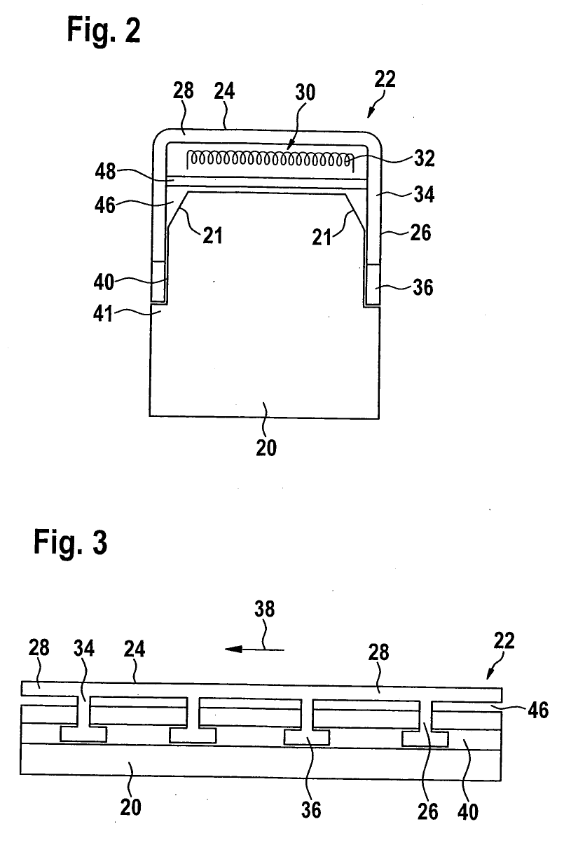

The heat sealing tool 10 comprises a support 20 (FIGS. 2 and 3) which is preferably made from a thermally insulating plastic material. An exemplary material is DELRIN (“DELRIN” is a registered trademark of E.I. Du Pont de Nemours and Co., Wilmington, USA). The support 20 has, for example, a rectangular cross section with slanted edge areas 21. The shape of the heat sealing tool 10 determines the lengthwise configuration of the support 20.

If, for example, the heat sealing tool 10 is U-shaped, the support 20 is then of corresponding U-shaped configuration with a first leg, a second leg and a crosspiece joining the two legs.

The support 20 holds a heat transfer device 22. This heat transfer device 22 has a substantially flat contact surface 24 serving to contact objects to be sealed for transfer of heat onto these. For example, films or portions of films may be sealed to one another by means of contact via the contact surface 24.

The heat transfer device 22 is made from a metallic material having a correspondingly high thermal conductivity. A non-stick coating such as a PTFE coating is preferably arranged on the contact surface 24.

The heat transfer device 22 comprises a plurality of bridge elements 26, via which the heat transfer device 22 is held on the support 20, and, in particular, is clipped onto this, i.e., it is held on the support 20 by spring clamping action.

The heat transfer device 22 comprises a heat body 28 on which the contact surface 24 is formed. Integrated, for example, by vulcanization into the heat body 28 is a heating device 30. In particular, this is a resistance heater with one or more heating coils 32 and electrical terminals 33a, 33b (FIG. 1). The heat body 28 can be heated up by means of the heating device 30, and heat can be introduced into an object to be sealed via the contact surface 24.

The heat body 28 is fixed in spaced relation to the support 20 by means of the bridge elements 26. To this end, the bridge elements 26 project via a bridge portion 34 beyond the heat body 28, i.e., the bridge elements 26 protrude via their respective bridge portions 34 from the heat body 28 in the direction of the support 20.

A base portion 36 is seated on a bridge portion 34.

It can be provided that a base portion 36 has a greater width in a direction 38 corresponding to the direction of the spacing between adjacent bridge elements 26 on a side of the heat transfer device 22 (FIG. 3) than the bridge portion 34 on which it is seated. The clamping surface is thereby increased.

A bridge element 26 preferably has a uniform thickness over its entire length.

The support 20 has one or more recessed areas 40 on which the base portions 36 bear. The bridge portions 34 may also bear thereon at least partially.

The recessed area or areas 40 can be formed at a stepped area 41, whereby a step is provided, which is oriented, for example, parallel to a side of the support 20 that faces the heat body 28. A blocking face with respect to further displacement of the heat transfer device 22 towards the support 20 is thereby provided, and a positioning of the heat body 28 at a spacing from the support 20 is thereby ensured.

(It is possible for no recessed area to be provided at end faces 42a, 42b, and for the heat transfer device 22 not to have any bridge elements 26 either in this area.)

The bridge elements 26 are integrally arranged on the heat body 28. Therefore, the heat transfer device 22 is of integral design. It is manufactured using, for example, a metal sheet on which the heating device 30 is positioned. The bridge elements 26 are, for example, punched out of it.

Bridge elements 26 are arranged on opposite sides of the heat transfer device 22. The bridge elements 26 are preferably seated at the edge of the heat body 28, so that they define the transverse dimensions of the heat transfer device 22.

For example, pairs of bridge elements are formed, which comprise two bridge elements arranged oppositely in the transverse direction perpendicular to the direction 38.

The bridge elements 26 form (spring) leg elements with which the heat transfer device 22 can be held, in particular, in a clamped manner, on the support 20.

The sum of the width of all bridge portions 34 in the direction 38 is less than the length of the periphery of the heat body 28 in the direction 38. In particular, it is considerably less. The length of the periphery of the heat body 28 in the direction 38 is at least three times and preferably at least five times greater than the sum of all widths of the bridge portions 34 in this direction 38. The surface area through which heat can be conducted from the heat body 28 in the direction of the support 20 via the bridge elements 26 is thereby minimized.

Furthermore, the width of the bridge elements perpendicularly to the direction 38 is considerably smaller in comparison with the transverse width of the heat body 28.

A space 46 is formed between the heat body 28 and the support 20. An intermediate layer 48 serving to increase the mechanical stability for fixing the heat transfer device 22 to the support 20 is arranged in this space 46. As a result of the intermediate layer 48, contact pressure on the heat body 28 does not cause it to sag to too great an extent in the direction of the support 20.

The intermediate layer 48 is made from a thermally insulating material in order to keep the dissipation of heat from the heat body 28 to the support 20 as low as possible.

The intermediate layer 48 is made, for example, of porous silicon. This intermediate layer 48 has a hardness lying, for example, in the order of magnitude of a Shore hardness of 3 to 5.

It is, in principle, possible for the intermediate layer 48 to be formed directly on the heat body 28. It may also be appropriately formed directly on the support 20.

In principle, the heating sealing tool 12 may be of the same design as the heat sealing tool 10, i.e., it may comprise a heat transfer device which is clipped onto a support.

In the assembly shown in FIG. 1, the heat sealing tool 12 serves, for example, to seal two sheets of film (indicated by reference numeral 50 in FIG. 1) in an initial area, with packaging material lying between the two sheets of film 50. Following this heat sealing operation (performed by means of the heat sealing tool), the two sheets of film with the packaging material are drawn in the direction 52, and the packaging material is positioned in a space 54 delimited by the legs 14 and 16. A heat sealing operation is then performed by the heat sealing tool 10 and the packaging material is thereby sealed all around. A severing from the remaining sheets of film is subsequently carried out at a tear-off edge 56 so as to obtain a package which can be individually handled.

Owing to the solution according to the invention, in which the heat transfer device 22 is held by means of bridge elements 26 on the support 20, the heat body 28 can be held on the support 20 at a spacing therefrom. A detachable fixing is thereby achieved, whereby the manufacture is simplified. Repair or exchange of the heat transfer device 22 can also be carried out in a simple way. (The heat transfer device 22 is a wear-and-tear part as it comes into contact with goods to be sealed via its contact surface 24; the support 20, on the other hand, is, as a rule, subjected to only very little wear and tear.)

The heat transfer device 22 can be manufactured from a metallic material with appropriate elasticity. The manufacturability is thereby simplified, and, for example, optional shapes for the heat transfer device 22 and, therefore, for the heat sealing tool 10 can also be accomplished.

Cold bridges between the heat transfer device 22 and the support 20, which may otherwise result in impairment of the sealing results, can be avoided.

Owing to the metallic heat transfer device 22, the heating device 30 can be arranged in a simple way thereon so as to obtain, in turn, an effective supply of heat to the heat transfer device 22.

Owing to the positioning of the heat body 28 at a spacing from the support 20 by means of the bridge elements 26, it is possible for the heat body 28 to be configured with a greater thickness, and, in particular, for a thicker sheet of metal to be used. In turn, the mechanical stability is thereby increased.

1. Heat sealing tool, comprising:
a heat transfer device for contacting objects to be sealed, said heat transfer device being made of a metallic material;
a support on which said heat transfer device is held; and
bridge elements by means of which said heat transfer device is fixed to said support;
wherein said bridge elements are arranged in one piece on said heat transfer device.

2. Heat sealing tool in accordance with claim 1, wherein a plurality of bridge elements are provided.

3. Heat sealing tool in accordance with claim 1, wherein the bridge elements are spaced from one another.

4. Heat sealing tool in accordance with claim 3, wherein the bridge elements have a width in a direction in which adjacent bridge elements are spaced from one another, which is smaller than the spacing between adjacent bridge elements.

5. Heat sealing tool in accordance with claim 1, wherein the heat transfer device is clipped onto the support by means of the bridge elements.

6. Heat sealing tool in accordance with claim 1, wherein the bridge elements are arranged on opposite sides of the heat transfer device.

7. Heat sealing tool in accordance with claim 1, wherein the bridge elements protrude from a heat body of the heat transfer device.

8. Heat sealing tool in accordance with claim 1, wherein the bridge elements protrude transversely to a contact surface of the heat transfer device.

9. Heat sealing tool in accordance with claim 1, wherein the support has one or more recessed areas for bridge elements to bear at least partially thereon.

10. Heat sealing tool in accordance with claim 1, wherein a bridge element has a bridge portion by means of which it protrudes from a heat body of the heat transfer device.

11. Heat sealing tool in accordance with claim 10, wherein a base portion for fixing the heat transfer device to the support is arranged on the bridge portion.

12. Heat sealing tool in accordance with claim 11, wherein the base portion is broadened in relation to the bridge portion.

13. Heat sealing tool in accordance with claim 12, wherein the base portion is broader than the bridge portion in relation to a direction in which adjacent bridge elements are spaced from one another on the same side of the heat transfer device.

14. Heat sealing tool in accordance with claim 10, wherein the sum of all widths of the bridge portions is considerably smaller than the length of the periphery of the heat body.

15. Heat sealing tool in accordance with claim 10, wherein the bridge elements are arranged at opposite edges of the heat body.

16. Heat sealing tool in accordance with claim 1, wherein the support is made of a plastic material.

17. Heat sealing tool in accordance with claim 1, wherein the support has slanted edge areas on a side facing a heat body of the heat transfer device.

18. Heat sealing tool in accordance with claim 1, wherein the support has one or more stepped areas on opposite sides for bridge elements to bear thereon.

19. Heat sealing tool in accordance with claim 1, wherein a heating device is associated with the heat transfer device.

20. Heat sealing tool in accordance with claim 1, wherein the heat transfer device comprises one or more heating coils.

21. Heat sealing tool in accordance with claim 1, wherein the heat transfer device has a substantially flat contact surface.

22. Heat sealing tool in accordance with claim 1, wherein a contact surface of the heat transfer device is provided with a non-stick coating.

23. Heat sealing tool in accordance with claim 1, wherein the heat transfer device is manufactured using a sheet of metal.

24. Heat sealing tool in accordance with claim 1, wherein a heat body of the heat transfer device is spaced from the support.

25. Heat sealing tool in accordance with claim 1, wherein an intermediate layer is provided between a heat body of the heat transfer device and the support.

26. Heat sealing tool in accordance with claim 25, wherein the intermediate layer is of thermally insulating design.
